(19) United States
(12) Patent Application Publication
(10) Pub. No.: US 2006/0177119 A1
(43) Pub. Date: Aug. 10, 2006

(54) Digital diagnosti video system for manufacturing and industrial process

(76) Inventors: Bernard M McPheely, Greer, SC (US); J Bruce Cantrell JR., Greenville, SC (US); Michael S O'Dea, Bedford, NH (US)

Correspondence Address: MCNAIR LAW FIRM, P.A., P.O. BOX 10827, GREENVILLE, SC, 29603-0827, US

(21) Appl. No.: 10/531,332

(22) PCT Filed: Oct. 24, 2003
(86) PCT No.: PCT/US03/33991

§ 371 Date: Dec. 29, 2005

Related U.S. Application Data
(60) Provisional application No. 60/421,492, filed on Oct. 25, 2002.

(30) Foreign Application Priority Data
Oct. 25, 2002 (US) 60421492

(51) Int. Cl. G06K 9/00

(52) U.S. Cl. 382/141

(57) ABSTRACT

A system for assisting in the diagnosis of errors in manufacturing machinery is disclosed wherein sensors are associated with the machinery at monitoring zones for detecting errors and generating sensor signals representing the errors. Video cameras are located at monitoring zones associated with specific sensors. A computer readable medium is in communication with the cameras for receiving video of the process. A set of computer readable instructions are embodied within the computer readable medium for receiving input selecting machine sensors and cameras, triggering, and producing the pre-event and post-event videos for the trigger signals. Operating instructions are for continuously storing video output in temporary memory, receiving sensor signals, and processing the sensor signals to determine if a trigger signal is required. After a trigger signal, video is copied from temporary memory into permanent memory to provide the pre-event video, and post-event video is recorded and stored in permanent memory.

This application claims priority on provisional application No. 60/421,492, filed on Oct. 25, 2002, and entitled Digital Diagnostic Video System For Manufacturing And Industrial Processes.

### BACKGROUND OF THE INVENTION

This invention relates to a system and method for assisting with the diagnosis of manufacturing machines and processes where a malfunction or error event has occurred in the operation. In particular, this invention relates to a digital diagnostic video system continuously recording and displaying a video of the machine operation and automatically producing a pre-event video, and a post-event video of prescribed durations, upon occurrence of predefined trigger events to assist in the determination of errors in the machinery operation based on one or more sensors in an integrated manner with control of the machinery.

In modern manufacturing processes, being performed at higher and higher machinery speeds, failures in the operation of the machinery often results in machine damage, and a halt in production. This results in lost time and money, as well as damage to the machinery. If the cause of the failure is not reliably corrected, the machinery will simply stop production again. Therefore, being able to reliably determine the cause of the fault and machinery failure has become increasingly more important in manufacturing. Fault events in machinery are normally detected using sensors positioned to monitor areas of the machinery prone to failure. Upon detecting a fault event, a sensor signal is sent to a programmable logic controller (PLC) controlling the operation of the machinery according to the fault. The PLC is responsible for the logic that operates the machines in normal operation, as well as operating the machinery upon receipt of a fault sensor signal.

Heretofore, the problem of downtime and expense of repair has been a problem in manufacturing and other industrial processes to which considerable attention has been given. Various types of video systems have been proposed for monitoring the operation and repair of machinery. For example, U.S. Pat. No. 5,844,601 discloses a remote video system, which allows technicians at a remote geographic location to assist operators in a manufacturing plant in the repair of machinery avoiding the need and expense of the technician travelling to the plant location. In addition, the remote video system can be used to train personnel in the plant using technicians at a geographically remote location. All of which eliminates the need for experts and other technical personnel to travel to the site of the machinery. However, it is not the purpose of the system to detect errors and failures during machinery operation, but rather to assist in the repair of any such errors.

Systems have been previously proposed using video output from a video camera stationed at an operating area of a machine in order to monitor the operation over a period of time. In the event that a machine operation failure occurs, the video recording can be played back. However, this type of system is not practical for monitoring multiple machine zones requiring multiple sensors and cameras, particularly on a continuous basis with machine operation. U.S. Pat. No. 6,211,905 B1 discloses a system for monitoring a manufacturing process in order to detect a defect in the product being manufactured, as opposed to the machinery operation. If a defect in the product is detected, the time the defect is detected can be used to search for a video of the defect. In this manner, defects such as a hole, tear, or other defect in a traveling web such as a fabric or paper web can be studied using the video display, as well as events surrounding the defect. However, the system requires the storage of large amounts of video output in permanent memory.

In other non related systems, the use of video recordings to diagnose an event have been proposed, for example in the field of compiling traffic accident data. In these systems, it is typical to use miniature video cameras mounted to a vehicle pointed in various directions to record events happening before an accident. Typically, additional accident data such as speed data, brake data, throttle data, steering data, etc. is stored along with the video so that the conditions existing before the accident can be reconstructed for analysis. Examples of these non related systems are found in U.S. Pat. Nos. 5,815,093, 6,246,933 B1, and 6,389,340 B1. Other general applications have included vehicle security systems, such as shown in U.S. Pat. No. 5,027,104, and personal security systems which detect the presence of persons intruding upon a secured area. In the personal security systems, it has been known to record video output from a video camera strategically located. Upon detecting an unauthorized intrusion a short video of the events happening before the intrusion is captured and a video recording of events after detection continues as long as the camera pixels are changing.

Accordingly, an object of the present invention is to provide a digital diagnostic system and method for diagnosing failures and faults in operating machinery so that the machinery can be reliably repaired without excessive downtime.

Another objective of the present invention is to provide a single interface between a digital diagnostic video system and a machine control and data analysis system so that a supervisor may have direct access to data and video concerning the machines' performance as well as to the cause of operating errors.

Another object of the present invention is to provide a diagnostic system and method for diagnosing error events in manufacturing machinery using multiple video cameras and sensors to trigger storage of video camera outputs according to predefined trigger events to provide effective event video for assisting in diagnosing the error.

Another object of the present invention is to provide a video diagnostic system wherein video inputs from various machine monitoring zones are continuously displayed on a video monitor and stored in temporary memory in real time during machine operation where upon occurrence of an preset trigger event, a trigger signal is generated to trigger a video storage routine storing pre-selected video input and other trigger information concerning the machine error.

Another object of the present invention is to pre-select trigger events constituting trigger signals which trigger the diagnostic system according to machine sensors selected to detect the errors and camera video inputs selected to be associated with the sensors and stored in computer memory depending on the application being made.

Yet another object of the present invention is to provide a diagnostic tool in the form of an integrated digital capture system comprising a pre-event video of the operation of machinery, manufacturing process, or industrial process and the like for a selected period of time before the trigger event and a post-event video after the event which may be displayed and studied for diagnostic purposes in an integrated manner while also controlling the operation of the machine in response to the error.

### SUMMARY OF THE INVENTION

The above objectives are accomplished according to the present invention by providing a digital diagnostic video system for diagnosing malfunctions and other errors in the operation of manufacturing machinery. The machinery typically includes a plurality of machine sensors located at monitoring zones for detecting prescribed errors and causing sensor signals to be generated upon occurrence of errors for use by the machine controller. The system comprises video cameras associated with the machine sensors located at monitoring zones for producing real-time video output of the machinery operation desired to be monitored by the cameras and sensors. A central control unit has a computer processor continuously receiving the video output from the cameras during normal machinery operation. A temporary computer memory communicates with the processor continuously storing the video output in real time. The processor communicates with the sensors for receiving the sensor signals to provide trigger signals when the sensor signals satisfy the conditions for prescribed trigger events. A permanent memory permanently stores a pre-event video including a first preset length of the video output depicting machinery operation occurring immediately before the trigger signal and storing a post-event video of a second preset length of the video output depicting machinery operation occurring immediately after the trigger signal. A computer program includes a set of operating instructions embodied in computer readable code executable by the processor to control the recording and storing of the pre-event and post-event videos. The program including capture instructions for copying at least the pre-event video from the temporary memory into the permanent memory in response to the trigger signal, recording the post-event video in response to the trigger signal, and saving the post-event video in the permanent memory along with the pre-event video to provide a trigger event video. The trigger event video may be displayed on the display monitor and replayed to assist in diagnosing the trigger events and errors. Preferably, the central control unit includes a display monitor associated with the processor having a display screen for continuously displaying the video output during machinery operation in real time.

The machinery typically includes a programmed logic controller (PLC) receiving the sensor signals for controlling normal machinery operation in response to the sensor signals. Advantageously, the processor is in communication with the PLC to receive and process the sensor signals for generating the trigger signal corresponding to a prescribed trigger event in machinery operation represented by one or more of the sensor signals. The processor is set up to produce the trigger signal in response to a combination of two or more of the sensor signals. A local area network (LAN) connects the machine PLC to the control unit processor for concurrent transmission of a plurality of machine sensor signals received by the PLC from the sensors. Preferably, the LAN includes an Ethernet, and the machine PLC includes a converter for converting the sensor signals for transmission over the Ethernet.

The computer program includes set-up instructions for selecting a first preset duration for the pre-event video and a second preset duration for a post-event video, selecting one or more machine sensor signals required to generate the trigger signal, and selecting one or more cameras producing the pre-event and post-event videos for the trigger event. The operating instructions include instructions for (1) continuously receiving a video of the machinery operation in real time, (2) continuously storing video in a temporary memory in real time, (3) continuously displaying the video on a display screen in real time, (4) continuously receiving available sensor signals, (5) processing the sensor signals to determine if the trigger event has occurred, and (6) continuing instructions (1) through (5) if a trigger event has not occurred. The operating instructions include instructions for generating the trigger signal and recording the time and date of the trigger event upon occurrence of the trigger signal; storing the video output according to a first preset duration allocated for the pre-event video and a second preset duration allocated for the post-event video upon occurrence of the trigger signal. Next, the processor copies video from the temporary memory into the permanent memory of the first preset duration to provide the pre-event video upon the occurrence of the trigger signal and begins the recording of the post-event video. The post-event video is stored in the permanent memory after the second preset duration has expired. Preferably, the operating instructions include instructions for storing the post-event video real time in the temporary memory containing the pre-event video in response to the trigger signal and copying the pre-event and post-event videos into a video file in the permanent memory. The video file may contain text representing the time, date, and a trigger name identifying location of the trigger event so that video before and after the trigger event and text information can be selected and displayed to assist in the diagnosis of the trigger event. Advantageously, the display monitor includes a touch screen input for inputting data and information into the processor.

In regard to another aspect of the invention, a computerized method for assisting in the diagnosis of malfunction and other errors occurring in the operation of manufacturing machinery is disclosed. Machine sensors are strategically placed at machinery monitoring zones prone to malfunction. The method comprises selecting specific errors which need to be detected in order to define trigger events at the monitoring zones requiring generation of trigger signals; and assigning a number of sensors at the monitoring zones required to detect the occurrence of a trigger event. A number of video cameras are associated with trigger events and sensors at the monitoring zones having video output sufficient to effectively diagnose errors occurring at the monitoring zones. The method includes continuously storing the video output in real time in a temporary computer memory during operation of the machinery, and continuously displaying the video output on a display monitor in real time while simultaneously storing the video output. Next, a pre-event video is produced from video output stored in the temporary memory upon occurrence of the trigger signal depicting machinery operation occurring before the trigger signal, and a post-event video is produced upon occurrence of the trigger signal depicting machinery operation occurring after the trigger signal. The pre-event video and post-event video are stored in a video file in a permanent computer memory of a computer readable medium along with text information identifying the trigger event. To speed up the storage routine for large numbers of cameras, the post-event video is stored in the temporary computer memory containing the pre-event video upon occurrence of the trigger signal, and the pre-event and post-event videos are saved from the temporary memory and stored in the permanent memory after the post-event video is completed.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a perspective view of a case packing machine for packing bottles into cases incorporating a diagnostic system according to the invention;

FIG. 2 is a perspective, schematic view of the case packing machine of FIG. 1 illustrating four machine monitoring zones where video diagnostic sensing and monitoring is provided;

FIG. 3 is a top plan schematic illustration of the four monitoring zones of FIG. 2;

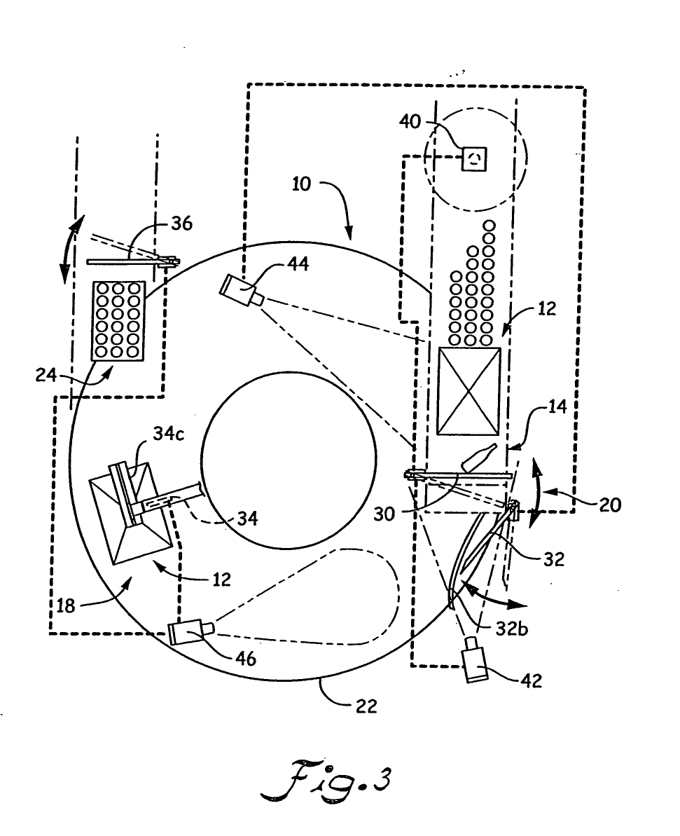

FIG. 4 is a schematic diagram of a digital diagnostic video system according to the present invention as applied to the four exemplary operating and monitoring zones of FIGS. 2 and 3;

FIG. 5 is schematic diagram illustrating a programmable logic controller of the machine having machine sensor terminals connected to a digital diagnostic video system according to the invention using an Ethernet connection;

FIG. 6A is a schematic diagram of a data packet of trigger information generated in response to a trigger signal indicating a machine failure triggering the diagnostic system according to the invention;

FIG. 6B is a schematic diagram illustrating a system video storage routine in response to a trigger signal according to the invention;

FIG. 6C is a schematic diagram illustrating another system routine for storing video in response to a trigger signal according to the invention;

FIG. 7A is a software flowchart illustrating operation of a digital diagnostic system according to the invention and FIG. 6B;

FIG. 7B is a software flowchart illustrating operation of another embodiment of a digital diagnostic system according to the invention and FIG. 6C;

FIG. 8 is a schematic diagram illustrating a digital diagnostic system for manufacturing machinery according to the invention applied to a plurality of machines networked in the system;

FIG. 9 is a flow chart illustrating instructions for initially setting up the diagnostic system to define a trigger based on one or more sensor signal inputs according to the invention using touch input screens shown in FIGS. 10-12;

FIG. 10 is a display screen with touch input illustrating selection of names for trigger events according to the invention;

FIG. 11 is a display screen with touch input illustrating selection of camera/sensor association settings, and selection of predetermined time durations for the pre-event and post-event video recordings according to the invention;

FIG. 12 is a display screen with touch input illustrating setting up conditions which constitute a trigger or trigger event require a trigger signal to be output by the system processor;

FIG. 13 a flow chart illustrating instructions for operating the diagnostic system in normal operation and operation in response to a trigger according to the invention using a touch screen input as shown in FIGS. 14-15;

FIG. 14 is a touch screen input illustrating video output from the four monitoring zones as denoted by camera/senor identification displayed on status bars for the monitoring zones; and

FIG. 15 is a touch screen input illustrating a record listing of trigger events and associated video display selectable from the list of trigger events according to the present invention.

### DESCRIPTION OF A PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. An object or module is a section of computer readable code embodied in a computer

Actual computer or executable code or computer readable code may not be contained within one file or one storage medium but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, programmed logic controller (PLC), or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions.

The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

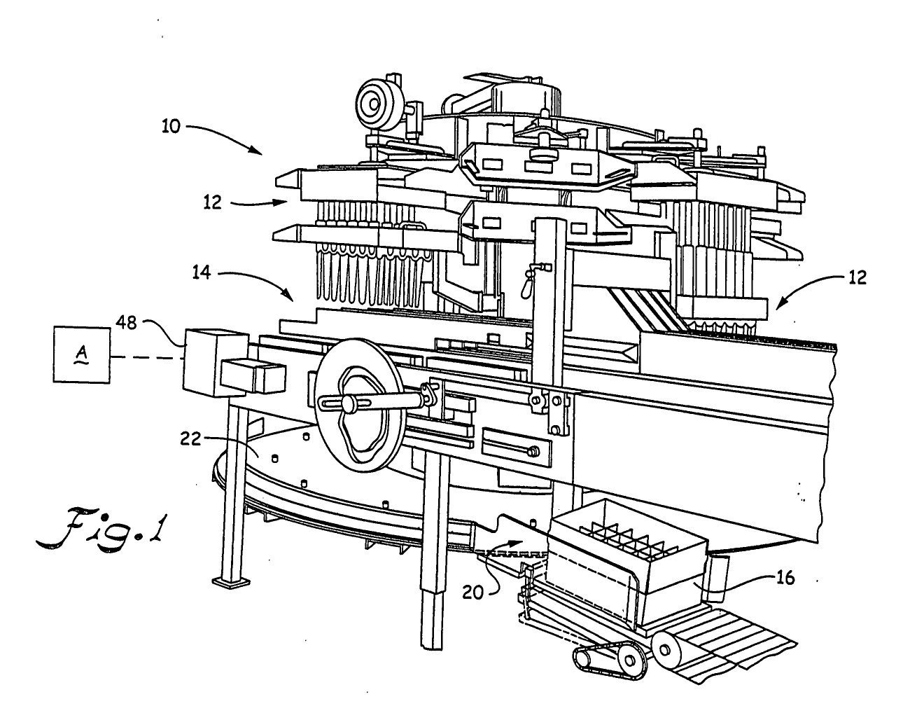

For purposes of explaining the invention, a case packing machine, designated generally as 10, for packing bottles into cases (FIG. 1) will be used to describe an application of a digital diagnostic video system, designated generally as A, according to the invention. It is to be understood, of course, the digital diagnostic system has application to a wide variety of manufacturing machinery and industrial processes, and that the case packing machine illustrated in connection with the invention is for exemplary purposes only. As can best be seen in FIG. 1, a case packing machine 10 is illustrated including a plurality of circularly arranged pickup heads 12 for picking up bottles at a pickup section 14 by means of plurality of bottle grippers and for depositing the bottles into empty cases 16 at a case packing section 18. There is a case indexing section 20 where empty cases are delivered onto a rotary case conveyor 22 in an indexed manner. There is a case removal section 24 where packed cases are delivered on to an exit conveyor 26 which conveys the packed cases away. Article pickup section 14, case packing section 18, case indexing section 20, and case removal section 24 are critical operation zones prone to malfunctions, machine failures, or other operating errors. Thus, in accordance with the present invention, monitoring of these zones for purpose of diagnosis is important. Of course, selection of these areas is for purpose of example, and not limitation. There are four video cameras 40, 42, 44, and 46 located in effective positions to monitor each zone. Multiple or single cameras may also be used at each zone. Any suitable video camera may be utilized at 30 and 32, for example, conventional color bullet cameras may be used. The cameras are preferably fixed to the machine frame or associated fixture, and operate continuously with the machine to monitor the designated machine zones on a full time basis with the full time operation of the machine or process. Machine sensors 30, 32, 34, and 36 are associated with cameras 40, 42, 44, and 46, respectively. One sensor is associated with one camera in the exemplary embodiment, except that sensors 34 and 36 are both associated with a single camera 46 in the exemplary machine because both sensor errors usually are created in the same operation area. Depending on the application, combinations of multiple cameras and sensors may be provided at a monitoring zone as necessary for effective monitoring, and depending on the complexity of the operation being monitored. For example, video cameras 40, 42 are located to continuously watch the operation at the bottle pickup station to detect a falling bottle. Camera 40 is located overhead of the bottle infeed conveyor upstream of pickup station 14. Camera 42 monitors the front of pickup station 14. A falling bottle will continue on the bottle conveyor and strike pivotal bar of sensor 30 while the remaining bottles will be lifted off the conveyor. Sensor 30 will generate a sensor signal 30a in this case. Video camera 44 is located to watch the operation of case indexing section 20 to detect the presence of a missing or jammed case 16. Sensor 32 for determining a missing or jammed case is illustrated as including a moveable bar 32 positioned behind a flexible rail 32a. A improperly positioned case 16 will cause the flexible rail 32a to bend inwardly causing movement of bar 32 and generation of a sensor signal. Sensor 34 associated with camera 46, detects an improperly loaded case or bottle jam at case packing station 18. An improperly loaded case or bottle jam normally is caused by interference which prevents one or more bottles from reaching the bottom of the case. In other words, one or more bottles remains in a high position because it has not dropped to the bottom of the case. In this case pickup heads will not descend completely during bottle deposit causing a roller 34b to strike a rocker arm 34c. Displacement of the rocker arm is sensed by sensor 34 which is provided in the form of a proximity sensor which generates a senor signal 34a when the sensor no longer detects the presence of the rocker arm. In this case, a hydraulic cylinder 34d quickly moves the rocker arm out of the way so that the pickup head and case are not damaged. Since the area upstream of the packing station is the most important zone in which to determine the condition of the case and the cause of the problem, camera 46 is focused on that zone. At case exit station 24, a pivotal bar sensor 36 is position to detect the presence of an elevated bottle which has not fallen to the bottom of the case. In this case, the elevated bottle will strike pivotal rail 36 causing generation of a sensor signal 36a and store video from camera 46.

To complete the discussion of the exemplary machine, the trigger sensors 30, 32, 34, and 36 described above, are typically used on the case packing machine without a digital diagnostic system according to the present invention. These trigger sensors are typically connected to a programmable logic controller (PLC) 48. PLC 48 continuously controls the operation of the machine during production. For this purpose a large number of sensor signals, e.g. 30, are normally transmitted to the PLC in addition to the 4 sensor signals mentioned above. For example, proximity switch sensors sense the passage or timing of a case or bottles, and a large number of sensors are used to actuate the various cylinders, motors, and other mechanisms for the continuous operation of the machine. Typically sensor signals 30a, 32a, 34a, and 36a described above, if received by the PLC will cause the PLC to shutdown the machine until the problem is corrected. In accordance with the present invention, these signals are also utilized to trigger the digital diagnostic system to be described more fully below. While sensor signals not passing through the PLC can be used in applications of the invention, mapping the signals in the PLC is the preferred way and most advantageous as can be seen from the detail description below. Thus, having described exemplary components of the manufacturing machine for purposes of illustrating the present invention, the digital diagnostic system will now be described in detail.

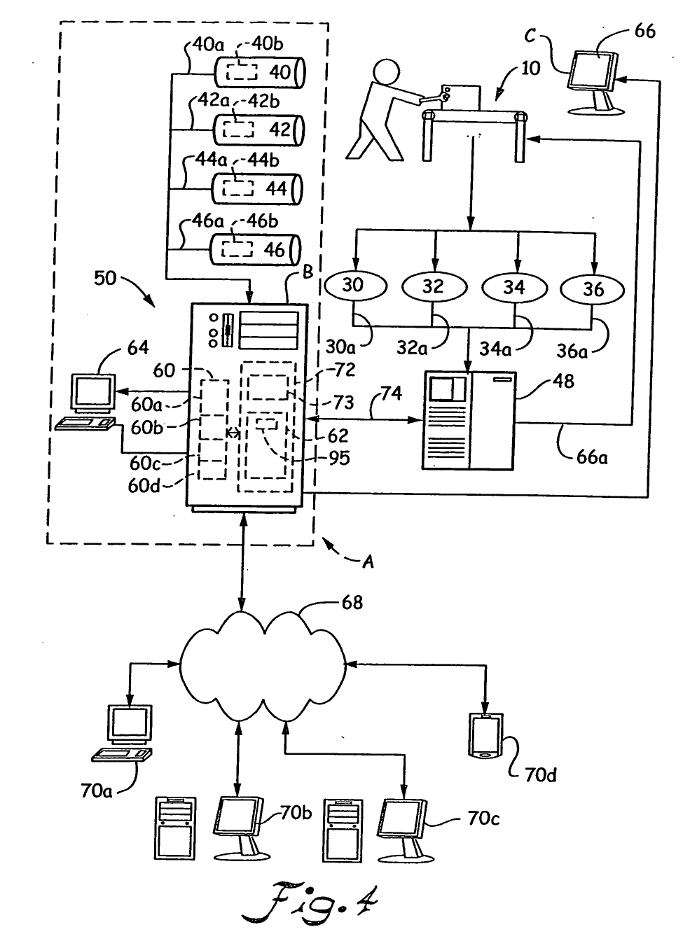

Referring now to FIG. 4, a schematic diagram of a digital video diagnostic system, designated generally as A, is illustrated according to the invention for diagnosing a malfunction or an trigger event in a manufacturing and industrial process. Diagnostic system A includes a central control unit, designated generally as 50, having a central control processor, designated generally as B, a display monitor 64, and touch screen or keyboard input. Control processor B may be a general purpose computer machine, a host computer, server, programmable logic controller, and the like. Bullet cameras 40, 42, 44, and 46, described above, are connected to system processor B. The processor includes a first, temporary memory 60 and a second, permanent memory 62. In addition, an auxiliary control display panel C may also be provided at machine 10 having an input device in the form of a touch screen 66, serving as a display screen.

As required in some applications, the diagnostic video system of the present invention may be connected to a wide area network 68 and accessed from a remote location connected to the network. At the remote location, one or more connected devices having displays may be provided such as a laptop 70a, computer terminals 70b, 70c, and/or personal assistant device (PDA) 70d. The remote devices also include input devices for two-way communication with processor B. The remote devices allow remote users to access all basic functions of system processor B in order to display the diagnostic videos and text remotely. In a most advantageous aspect of the invention, the digital diagnostic system may be combined with a remote video system as disclosed in U.S. Pat. No. 5,844,601, which patent disclosure is incorporated in this application by reference. When the two systems are combined over a network, the diagnostic history may be reviewed as disclosed herein, and then the machine may be repaired with the assistance of remote video and audio as disclosed in the patent.

A computer readable medium 72 is in communication with processor B (FIG. 4). Monitor 64 includes a touch screen and/or pop-up keyboard to provide for the user to interface with the computer readable medium. Computer readable instructions 73 for system setup and operation embodied in computer readable code reside in computer readable medium 72. Server B allows access to information to be exchanged with computer readable medium 72 by terminals 70a-70d via network 68. It is noted that the communications method between the terminals and the server can be LAN, WAN, Internet, wireless or any other communications means known in the art. Video cameras 40, 42, 44, 46, are in communications with processor B and thereby in communications with computer readable medium 72 so that video information captured by the video cameras can be stored in permanent memory 62 of computer readable medium 72. The cameras capture video information of a manufacturing process being performed by manufacturing machine 10. PLC 48, controlling machine 10, is advantageously in communications with server B so that the signals 30a-36a from machine sensors 30-36 is communicated from the PLC to server B through communications pathway 74. As noted earlier, sensor signals from the machine sensors are conventionally transmitted to the machine PLC programmed to control normal operation of the machine. Typically, certain sensors will stop the machine while others may be for timing, switching, etc. In accordance with the present invention, operation of the digital diagnostic system is triggered by one or more sensor signals transmitted to processor B via the PLC. Preferably, this is done by wiring server processor B of the diagnostic system directly to the PLC so that signals appearing at input terminals of the PLC appear simultaneously at server B. Alternately, the prescribed sensor signals can be concurrently transmitted from the sensors to each of PLC 48 and server B.

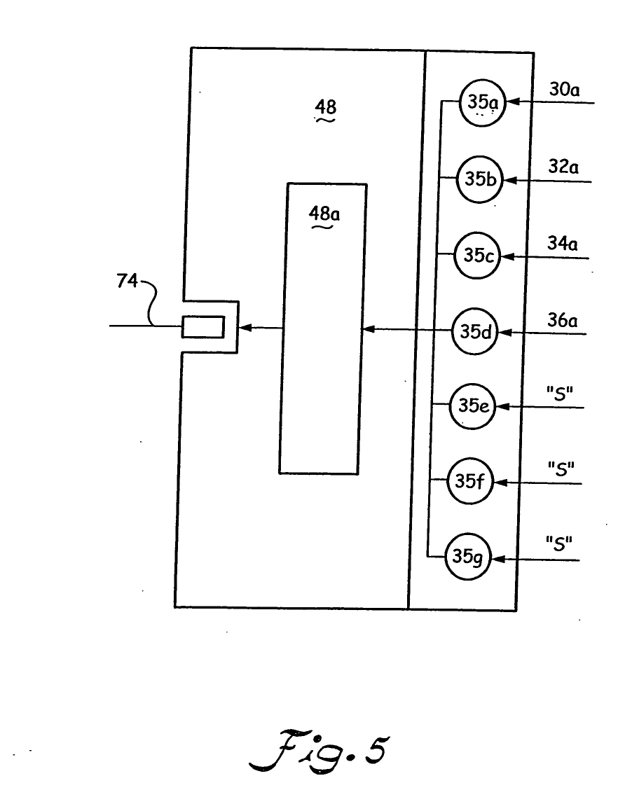

Referring now to FIG. 5, PLC 48 is illustrated as including a number of input terminals 35, for example, contact terminals 35a-35g are shown. It being understood that a PLC for a complex machine will have many more terminals. PLC logic 48a is provided to convert the impulses received into a signal that can be transmitted over communication pathway 74, for example, as an Ethernet line. Other local network connections may also be used whereby any signals at the terminals are simultaneously transmitted to server B, as well as any other electronic communication devices on the network.

For purposes of understanding the invention, the terms sensor signal or trigger signal will be used. Sensor signals are all the signals coming from the machine sensors typically ranging up to 30 or more signals. A trigger signal means one or more of the sensor signals coming from the machine sensors which are predefined as a trigger or trigger event, i.e. an event requiring triggering of the diagnostic video system. A trigger signal may be the same as a sensor signal or may be determined by a plurality of signals. In the illustrated embodiment each of the sensor signals 30a-36a is programmed to be recognized as a trigger signal by itself for purposes of explanation of the invention (FIG. 4). In many applications however, it is necessary to process more than one sensor signal in order to determine if a trigger event has occurred because of the complexity of the machine operation at the monitoring zone. A trigger signal is an event requiring capture of a first video of pre-event happenings, and a post-event video of post-event happenings. A trigger signal is normally accompanied by stoppage of the machinery. For this purpose, computer readable instructions 73 process sensor signals and determine if a trigger event has occurred according to predefined criteria.

Having the above meanings in mind, the digital video diagnostic system of the present invention will now be described with reference to FIGS. 4-7. Live video output 40a-46a from video cameras 40-46 are continuously streamed to system processor B of the digital diagnostic signal. The video output are continuously stored in temporary memory 60 of the processor and displayed on monitor 64. Temporary memory means ram or any other fast memory typically lost when power is off to the device or processor. Data saved in permanent memory 62 is not lost when power is lost. Video output 40a-46a from cameras 40-46 are continuously placed in temporary memories 60a, 60b, 60c, 60d, respectively, while the system is running to provide a pre-event video 54c of a preset duration depicting operation of the machinery or process from each camera and monitoring zone prior to the trigger. This video of pre-event history can later be used as a diagnoses of the event. The most important pre-event knowledge is what happens just before the event. Accordingly and advantageously, a video of only a short duration is ordinarily needed. For example, a 5 second video constantly records 30 frames per second at a resolution of 640×480, or 150 frames, which is ordinarily sufficient. In addition, the processor produces a post-event recording 54d of operation after the event having a second, present duration. The length of the pre-event and post-event recordings may be selected by the system user, and can be pre-set anywhere from 0 to 60 seconds for example. In essence, instead of having someone stand and watch the bottle pickup and deposit into an empty case, the eyes of video cameras continuously watch the operation.

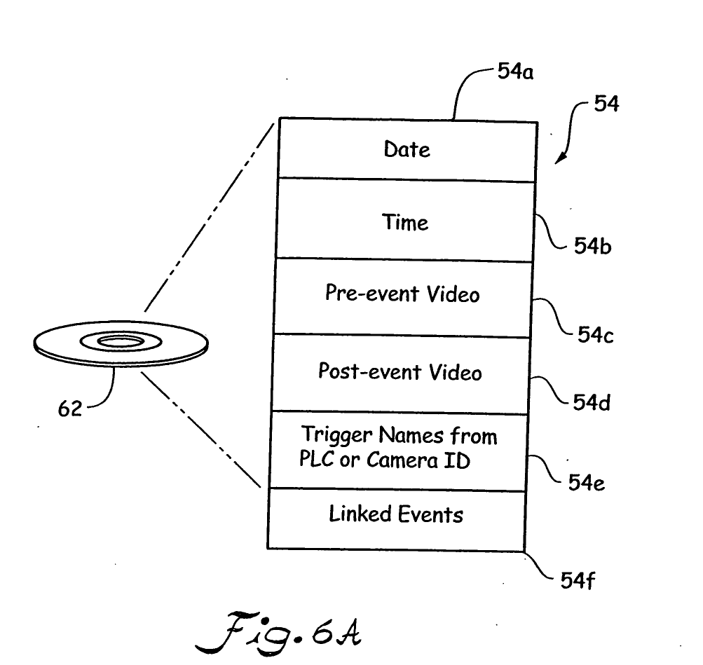

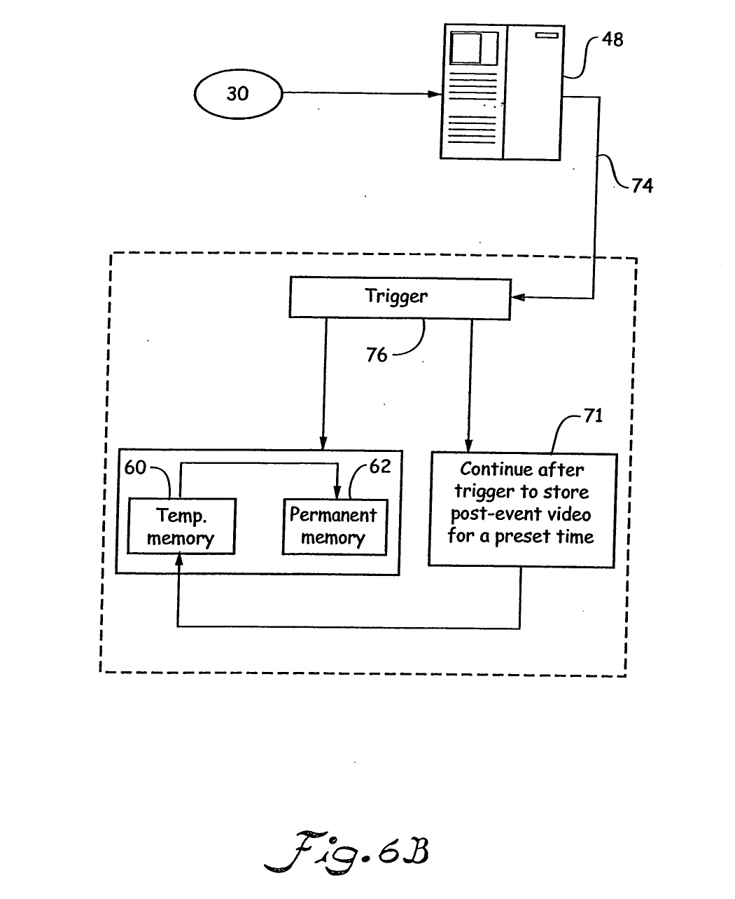

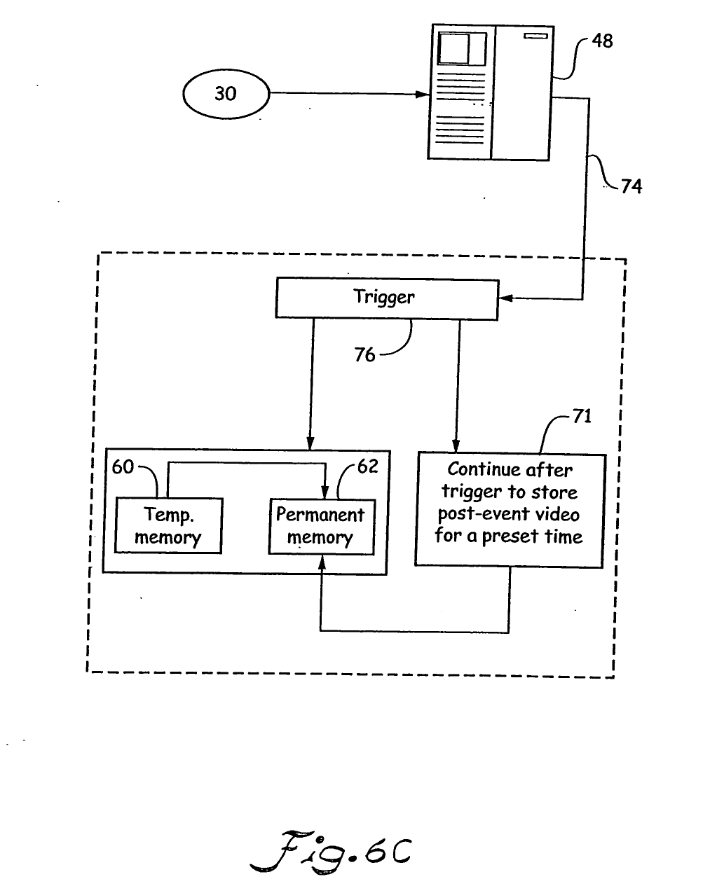

As can best be seen in FIG. 4, machine sensor signals 30a-36a received by processor B contain trigger information from machine PLC 48. An example of trigger information, designated generally as 54, is indicated in FIG. 6 as containing a date 54a of the trigger, time 54b of the trigger, the pre-event video 54c, post-event video 54d, trigger name 54e, and stored linked events 54f, such as the location within the PLC code where the trigger occurred. The instructions contain instructions for determining whether the sensor signals constitute a trigger. The system may be configured so that when a particular trigger signal is received, the pre-event video and post-event video is stored from a single camera or a plurality of cameras. Further, the configuration may be recognized as a single sensor signal or a combination of sensors as in a trigger, or signals received in a particular order or with a particular frequency, or not in a particular frequency.

FIGS. 6A and 6B illustrate routines for storing the pre-event and post-event videos according to the invention. Set-up instructions embodied in computer readable code, to be explained more fully below, allow the user to select a first preset duration for the first, pre-event video, and a second preset duration for the second, post-event video. The routine the system undertakes in recording and storing an event is illustrated in FIG. 6A. The routine begins when a sensor transmits information to PLC 48. The system is able to view the information from PLC 48 through Ethernet connection 74. If the sensor signal information from PLC 48 constitutes a trigger, the system begins a routine of producing an event video. While the system is receiving video it continuously records and stores the video in temporary memory, RAM 60. For example, a ring buffer is used, and input is stored, in a first in first out (FIFO) format. As video input comes in it is written in the ring buffer. Once the ring buffer has been filled the incoming video begins to overwrite the oldest video that had come into the circular buffer. Thus, the ring buffer always contains the most recent video for the amount of preset video. For example, if a desired event calls for 30 seconds of pre-event and 30 seconds of post-event video, then the ring buffer for that camera will be pre-set to a maximum of one minute of video. Once a trigger 76 has been received the system continues to store video at 71 in temporary memory 60 for the preset amount of time post-event, i.e. 30 seconds. Once the time has elapsed, the ring buffer is full and contains one minute of only the pre and post-event videos, according to the preset durations, i.e. 30 seconds each. The pre and post-event videos are copied from temporary memory 60 into permanent memory 62 as a single trigger event video 95. A file containing all the trigger event video is now stored in permanent memory 62, and may be accompanied by any associated text in any suitable manner.

In FIG. 6B, an alternate routine for storing the pre-event and post-event videos is illustrated. Temporary memory 60 is set to only store the preset pre-event video, e.g. 30 seconds. Upon the occurrence of a trigger signal 76, the pre-event video is immediately stored in permanent memory 62. Trigger signal 76 triggers the continued recording and storage of video at 71a directly into permanent memory to provide the post-event video until the preset duration of the post-event video is reached. Again, an event video file 95 may be created in permanent memory containing the pre and post-event videos. This embodiment allows for longer post-event video to be recorded and stored by recording the post-event video directly into permanent memory. On the other hand, storing both the pre-event and post-event in temporary memory provides for quicker processing which is important when using a large number of cameras, for example, upwards to 16 cameras and more. Typically the invention will be utilized with complex machinery and have a large number of cameras so that the storing and processing of the pre-event and post-event videos from the temporary memory is preferable. To provide quicker processing for large numbers, it has been found, according to the invention, advantageous to provide individual compression chips 42b-42b associated with the cameras 40-46 to compress the output of each cameral before the video output is transmitted to processor B. This facilitates the use of a large number of cameras because it provides for the transmission of decreased data over the transmission lines to the processor as well as frees up the processor to handle more cameras because the data is not compressed by the processor.

In addition, use of temporary memory allows for instantaneous creation of an event file and instantaneous viewing of the event file. Using permanent memory over a longer period of time is prohibitive in cost and, more importantly, is slower and does not allow for instantaneous file creation and file viewing. With temporary memory constantly storing the video input, creating an event video file containing pre and post-event video is achieved instantaneously. If the video is stored in a large permanent memory then a search routine must be used to find the desired video. Using this search routine does not allow for instantaneous viewing of event files as these files are not created instantaneously. Thus, while using permanent memory is fine for performing quality control on articles of manufacture, it is far more advantageous to use temporary memory when monitoring a manufacturing line for problems with the line itself.

The event video, along with text information (trigger name, date, time, location, and PLC information) are stored for subsequent retrieval and viewing through terminals 64, 70a-70d, and/or control panel display 66. The text information can be stored as a text file and associated with the video file. Preferably, the text information is used as the name of the video file. This ensures that the text information is always associated with the video. Since the trigger name, date, time, and PLC information can be associated with information stored according to the determination of a trigger, the stored information can be indexed, stored and retrieved by any of these fields. This allows the user to retrieve the stored event video and other information based upon date, time, trigger name, camera ID, or sensor ID, to better assist the user in the diagnoses of any errors in the manufacturing process. Further, since a trigger can store video information from multiple cameras and the video information from each camera can be stored chronologically, video information from each camera can be presented to the user in time sequence to allow a viewing of several areas, regardless of physical location, of the manufacturing process. As cameras can have different views of the same location of a manufacturing process, different location of the manufacturing process, or even different machines performing the manufacturing proceeds, the user can review all configuration for triggers and have the associated videos chronologically synchronized to view the manufacturing process in many ways.

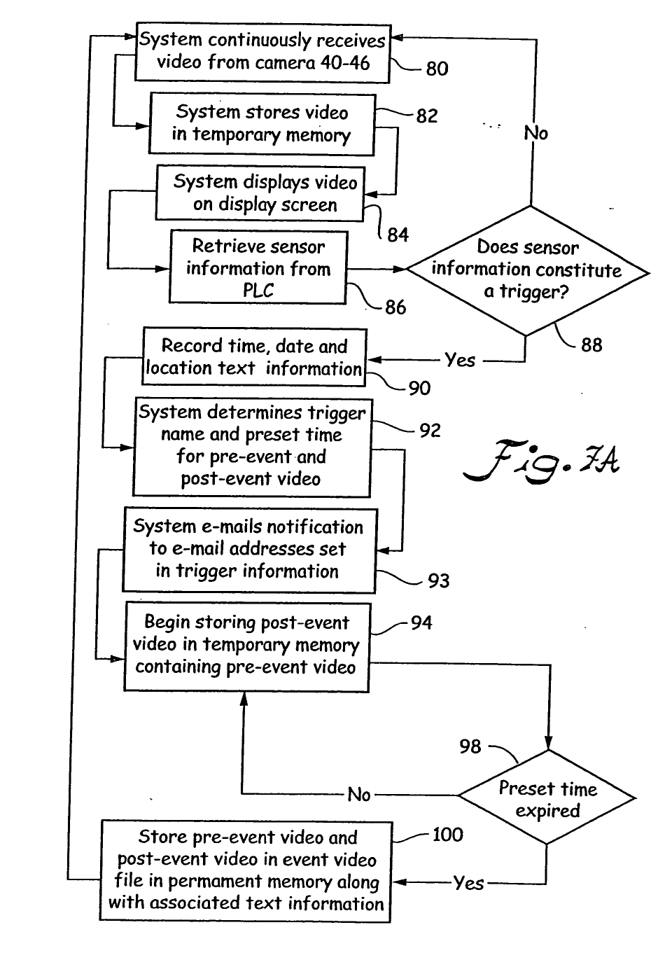

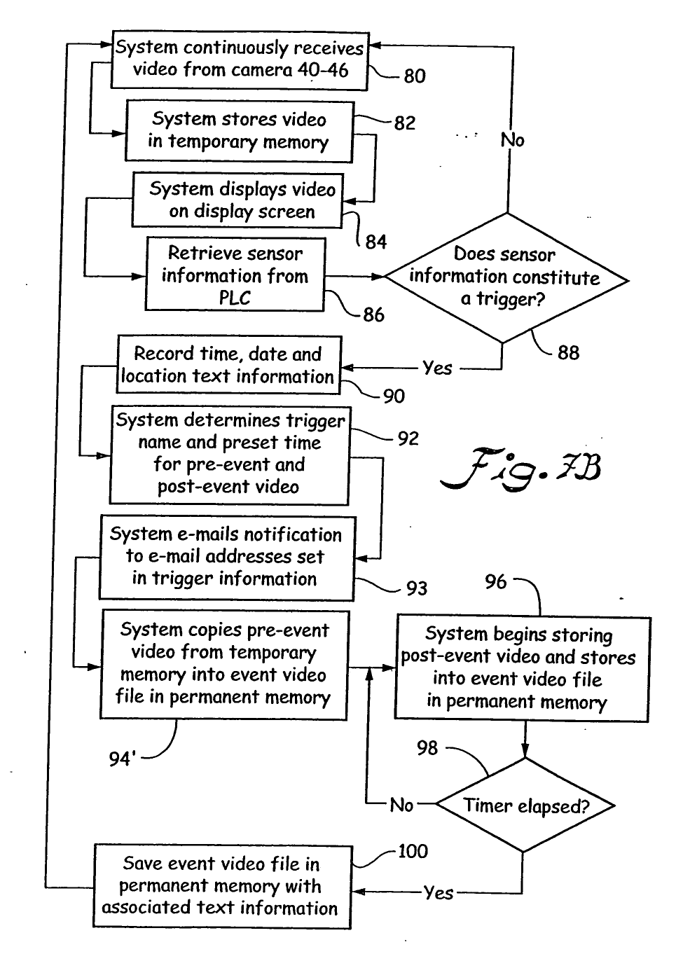

Referring now to FIG. 7A, a flow chart is illustrated for operation of the digital diagnostic system of the present invention during machinery operation where video storage is implemented by the routine of FIG. 6A. The flow chart includes blocks of operation implemented by one or more sets of computer readable instructions of code 73. Beginning at step 80, the system continuously receives video from cameras 40-46 at the monitoring zones. The video is received and continuously stored in temporary memory at step 82. Concurrent with storing the video, at step 84, the video is continuously displayed on the desired monitor screen such as system server screen 64 and/or one or more of the remote devices 70a-70d. The system also continuously receives sensor signals from the PLC at step 86 while storing and displaying video from the video cameras. The system is constantly able to determine if the sensor signal information constitutes a trigger at step 88. So long as the sensor information does not constitute a trigger the system continues going through steps 80, 82, 84 and 86. Once the sensor signal is determined to constitute a trigger at step 88, the system advances to step 90 and records the trigger name, time, day, and location information as text. This text information is important and is stored, along with the trigger event video, in data file 95. At step 92, the system processor determines the trigger name associated with the sensor signal, or signals, and determines the preset times for the pre-event video and post-event video durations. As an option at step 93, the processor determines if the trigger name has been configured to notify an individual via email. If an email is needed, the system will notify the selected individual. At step 94, upon occurrence of the trigger signal, the system begins storing post-event video in temporary memory which also contains the pre-event video. At step 98, a determination of whether the preset time for the post-event has expired is made. When the preset time has expired, the stored pre-event video and post-event video are copied and stored in an event video file in permanent memory along with the text information associated with the trigger at step 100.

Referring now to FIG. 7B, the operation of the system will be described using the video storage routine of FIG. 6B. Operation of the system is the same from step 80 to step 93. However, at step 94 a new step 94 is implemented which includes copying the pre-event video stored in temporary memory into an event video file in permanent memory at 94a. At the same time of the trigger and copying the video into an event video file in permanent memory, the system begins recording and storing the post event video into the event video file at 96. At 98, a determination is made as to whether the preset time has expired for the duration of the post-event video. When the time is satisfied, the entire event video file 95 is saved with the text information associated with the trigger at 100. The system then repeats itself upon resumption of the machine operation, that has been stopped.

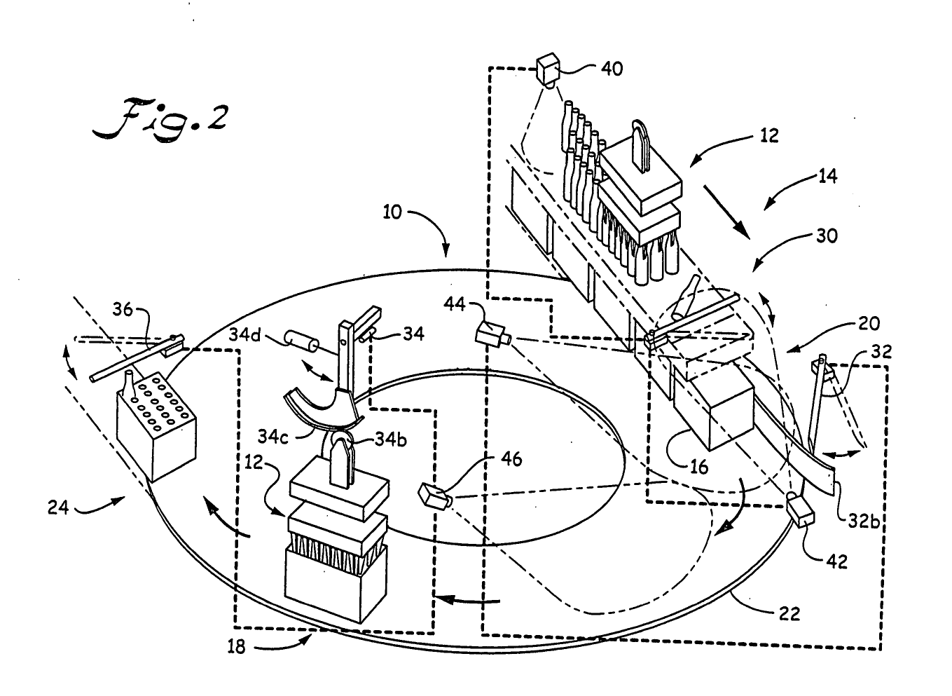

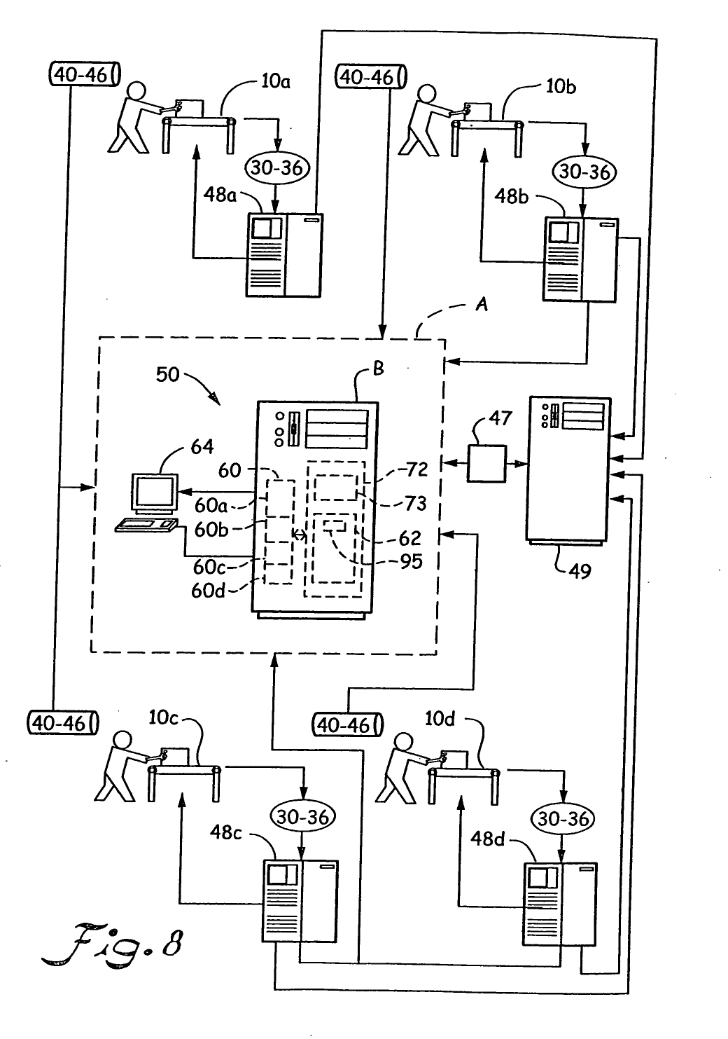

As can best be seen in FIG. 8, the digital diagnostic system of the present invention can be used with a plurality of operating machines 10. In the illustration of FIG. 8, there are four such machines 10 illustrated, machine 10a, 10b, 10c, and 10d. Each machine has its own respective PLC controller 48a, 48b, 48c, and 48d. In addition, each machine is the same as the machine shown in FIGS. 1-2, each is equipped with the same sensors 30-36 and cameras 40-46. All of the machines are fed into a central processor B.

As has been disclosed, several different forms of sensor signals can be used to trigger system operation. The sensor signals can be hardwired to the system, connected through the PLC, or transmitted by any other suitable means. For example, it is contemplated that a wired or wireless photo eye sensor can be used, particularly small or portable systems. The photo eye sensor is a simplified sensor that can be used as an overall system malfunction sensor. Most manufacturing machinery includes a signal light at the top of the machine that turns or flashes red upon the line being stopped. The photo eye sensor does not sense a specific error on the actual manufacturing line. It simply senses a change in state in the light around the top of the machine indicating that the light has gone on. The photo eye sensor then sends a signal to the system indicating a trigger, as the line has stopped. The trigger is sent to the diagnostic signal as a trigger signal 76 to being the video production described above in regard to FIGS. 7A and 7B. In this application, all of the cameras will be selected and activated to produce the event video.

In addition, when the diagnostic system is used with one, or multiple machines, the system may be advantageously interfaced with a conventional machine monitoring system, such as a system control and data analysis system commonly referred to as a SCADA system, to monitor error and malfunction information along with g of machine performance data. For this purpose, as can best be seen in FIG. 8, a SCADA system, designated generally as 49, normally connected to the machine PLC for control purposes and to receive alarm signals from the machine sensors transmitted to the PLC. For example, in the illustrated embodiment, the machine PLCs 48a-48d are connected to the SCADA system by a suitable communication paths 49a-49d, respectively. The communication path may be an Ethernet or any other suitable communication path for delivering multiple signals to the SCADA system. Typically, SCADA systems receive normal machine operating signals such as those from the machine PLC, as well as other sensors, to monitor machine performance such as run time, down time, speed, etc. When interfaced with the digital diagnostic system of the present invention, the SCADA system may also provide information to the user for why the machine has failed, that is, to diagnose the machine errors from a single location where the machine performance is monitored. An interface program 47 is provided with computer readable instructions for interfacing the processor B of the digital diagnostic system and the SCADA system 49 which also may include a computer machine, server, host, etc.

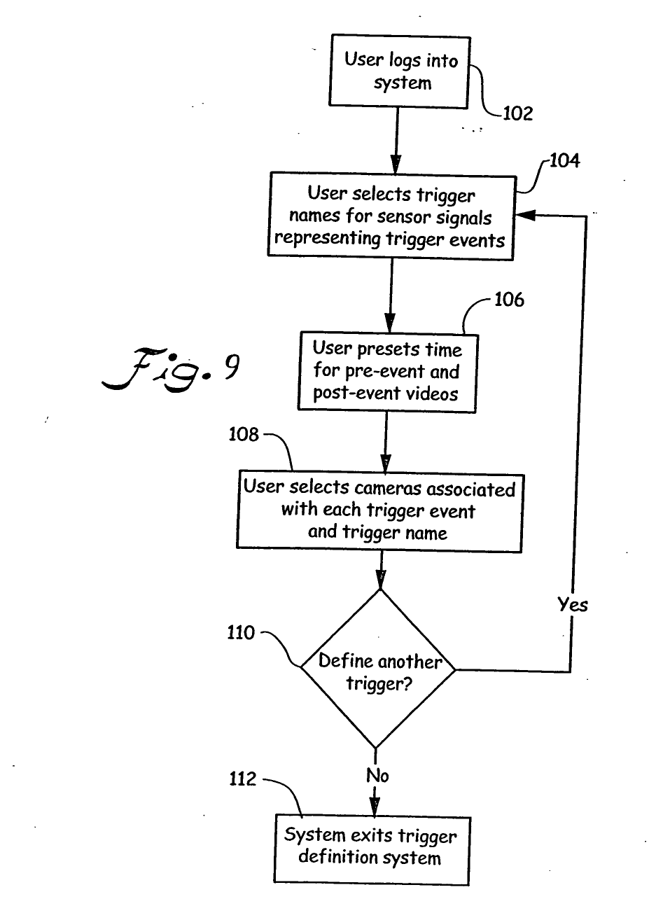

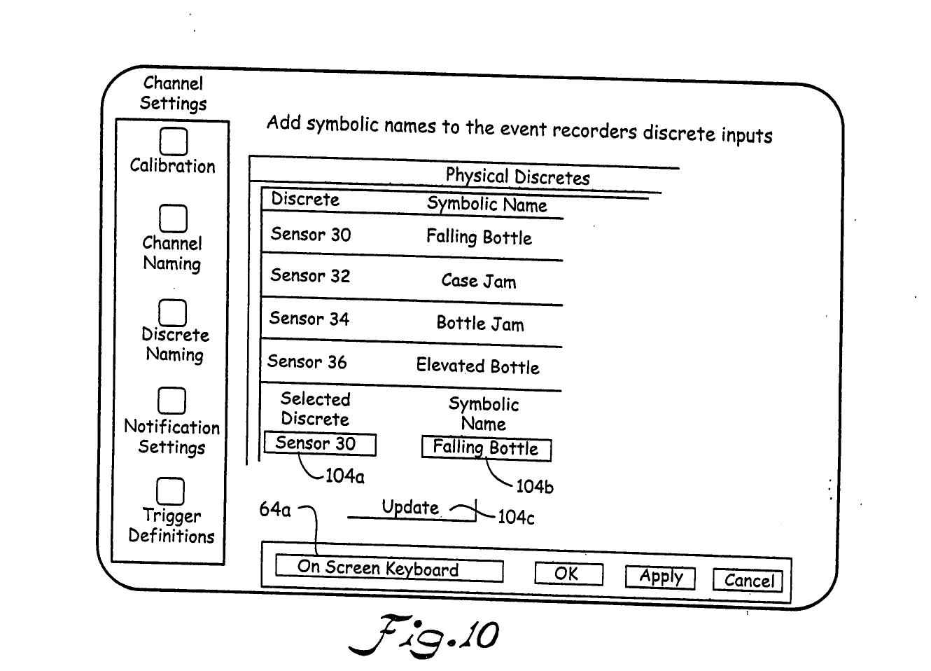

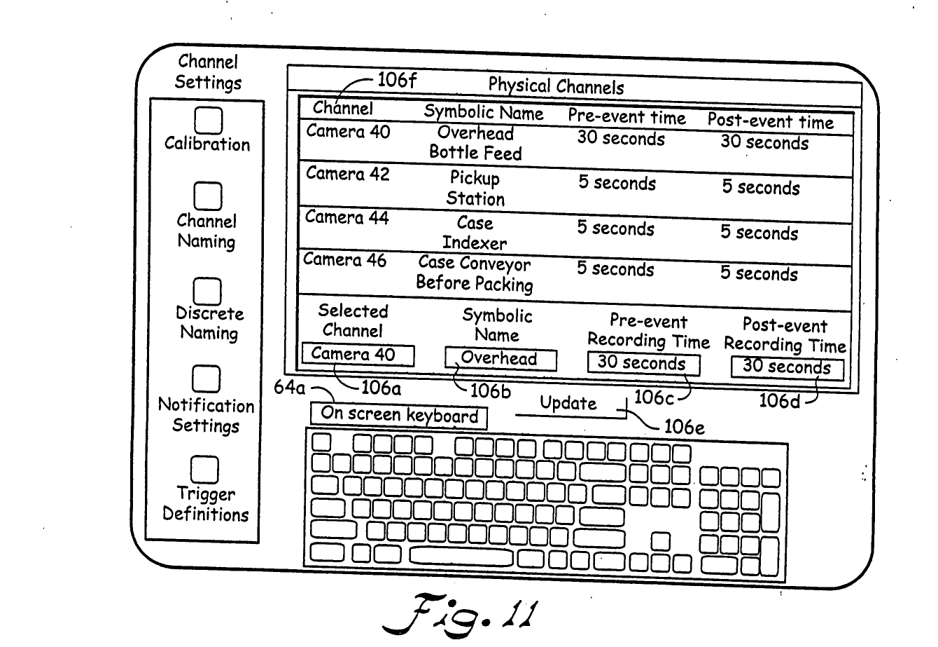

Referring now to FIGS. 9, 10 and 11 the process of initially setting up the system and creating one or more triggers for the above operation will be described. At step 102 in FIG. 9 the user logs into the system. At step 104 the user names one or more sensor signal inputs received from PLC 48 that constitute a trigger. FIG. 10 shows how a user selects names for triggers in step 104 using a display and input screen with a pop-up keyboard 64a. As is shown, discreet inputs are listed as sensor 30, sensor 32, sensor 34 and sensor 36 on display screen 64. The discrete inputs represent sensors 30-36. At 104a a selected discreet input is shown listed as sensor 30. A symbolic name that is associated with sensor 30 is shown, input at 104b, as a “falling bottle.” The user can type in the symbolic name in text box 104b using the onscreen keyboard, (see FIG. 11). Once the user is satisfied with the name they have chosen for the input, they click update button 104c. This associates the name “falling bottle” with any sensor signal input through sensor 30, i.e. sensor signal 30a. Each single sensor signal, 30a-36a, represents an trigger event having an associated trigger name requiring a trigger signal to be generated by the system.

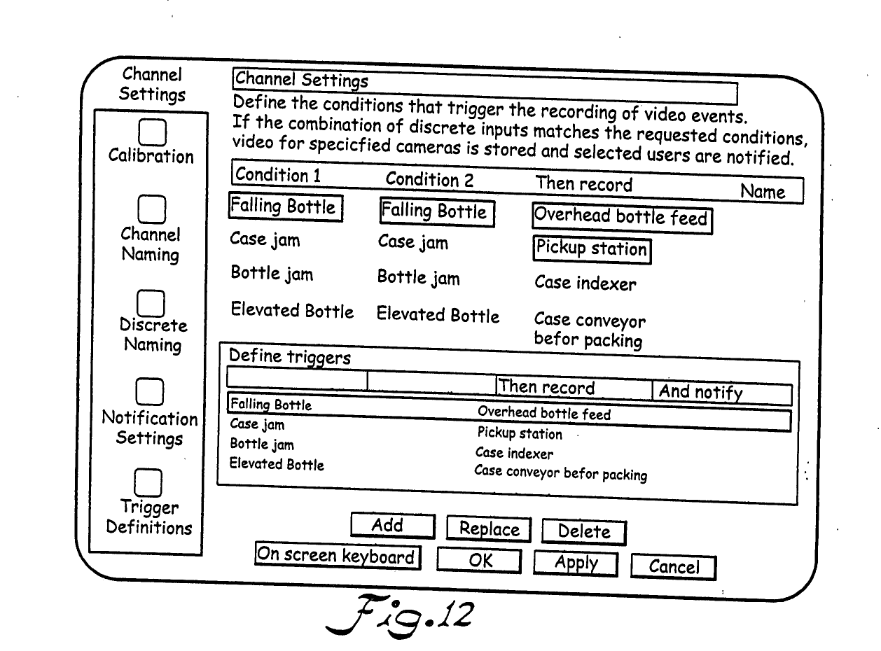

After selecting the error and associated trigger name,the user then selects which cameras are associated with a trigger event and sets the time duration for the pre and post videos at step 106 for each camera and trigger event, as can best be seen in FIG. 11. In FIG. 11 the cameras are listed by number and, in this example, there are four cameras camera 40 through camera 46. In this example, camera 40, corresponding to overhead bottle feed camera 40, has been given a symbolic camera name of “overhead bottle feed.” The user selects a channel to edit by tapping the area associated with that channel in the channel listing shown as 106f. The selected channel that appears in text box 106a. Here the selected channel is camera 40. The name is shown in text box 106b. The user could edit the name here with the on-screen keyboard shown as 64A. The user then can preset the duration of a pre-event video from camera 40 through pull-down menu 106c. Pull-down menu 106c contains various amounts of time that can be used for pre-event recording. These times can range anywhere from as small as five seconds to as much as two minutes using suitable RAM memory. A duration for a post-event video recording from camera 40 can then be selected through pull-down menu 106d. The post-event video duration can be for as small an amount as five seconds, to much larger amounts than the pre-event recording time, as much as one or more hours in alternate arrangements of the invention such as the storage routine of FIG. 6b. In the illustrated example, the user has selected 30 seconds before and 30 seconds after the trigger event for camera 40 by pressing update button 106e. Pressing this button saves the configuration for video stored from overhead camera 40. Presetting the amount of time for each camera also allocates the proper amount of RAM. As shown in FIG. 4, each of the four cameras has its own space in RAM 60, shown as section 60a, 60b, 60c, and 60d. Pre-allocating the amount of RAM ensures that no camera will run out of space to store video, and that all cameras always have the proper amount of pre and post-event video time following a trigger. At step 108, the user selects and associates the cameras whose video input will be stored for each trigger name. This setup process is repeated for each trigger event and name to be programmed into the system, as shown in FIG. 12. For example, camera 42 is associated with the camera name “pickup station,” camera 44 with the name “case indexer,” and camera 46 with the name “case conveyor before packing.”

Referring now to FIG. 12, the user can select multiple cameras and video input for pre-event and post-event video storage when a named trigger occurs. In this example, cameras named the “overhead bottle feed” camera 40 and “pickup station” camera 42 are selected to video a “falling bottle” trigger. As configured in step 106, the overhead and pickup station cameras will store for 30 seconds before and after the event, and 5 seconds before and after the event, respectively. It is to be understood, of course, different pre and post times can also be selected rather than equal times. If the user is finished defining triggers at step 110, the system exits the trigger definition section at step 112. The user defines the other trigger, and then returns to step 104 where other sensed trigger events and trigger names, e.g. case jam, bottle jam, and elevated bottle, are associated with camera recordings. The screen shown in FIG. 12 also allows for setting notification, which allows for automatic emailing of necessary parties.

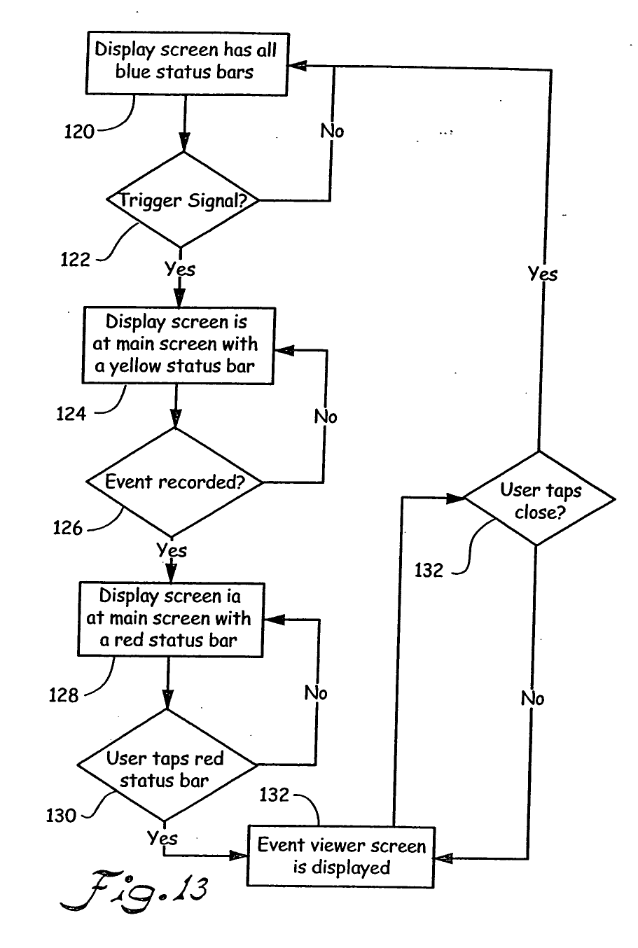

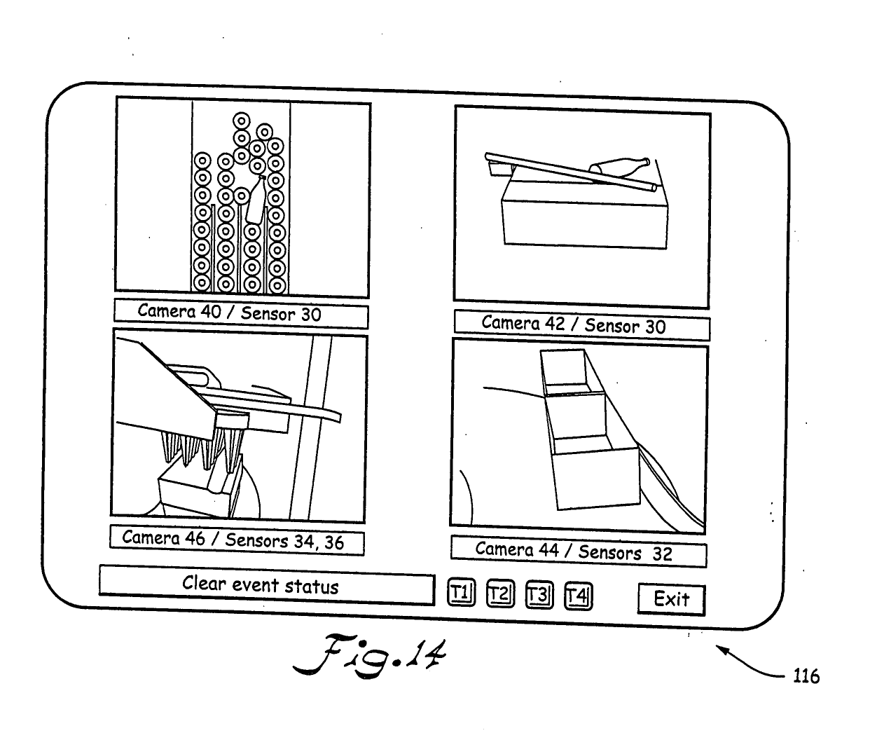

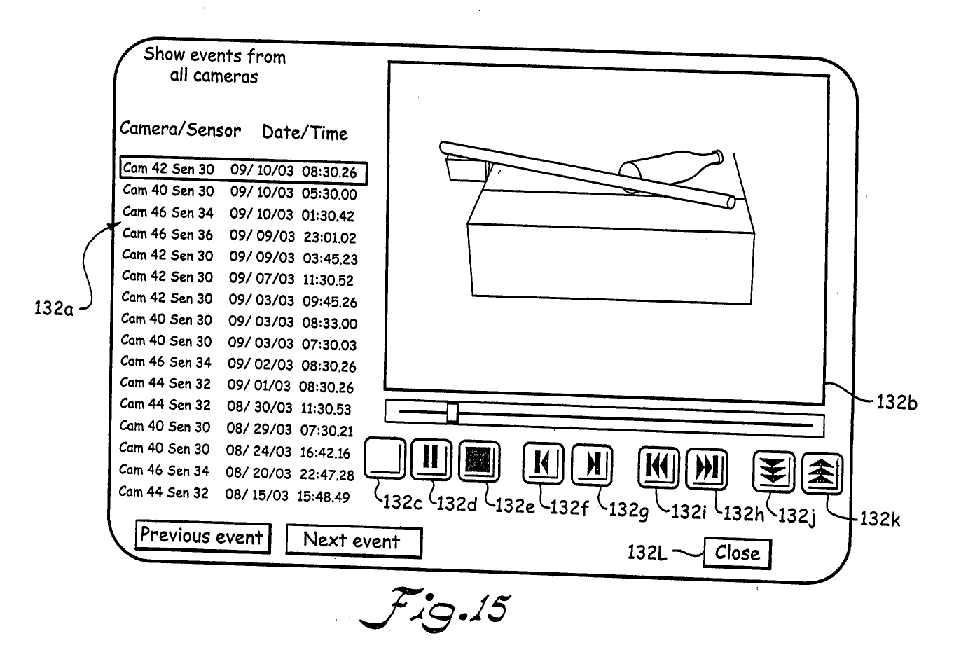

Referring now to FIGS. 13, 14, and 15, the operation of the system will be described with regard to flow charts and display/input screens. FIG. 13 illustrates a flow chart of continuous system operation implemented with software using input from display/input screens shown in FIGS. 14 and 15. FIG. 14 illustrates an exemplary main display screen 116 normally appearing while the system is continuously operating. In the illustrated embodiment, video from four cameras 40-46 is continuously displayed and stored in temporary memory 60. Underneath each camera there is a respective status bar indicated as 123a, 123b, 123c, and 123d. The status bars show the associated cameras and sensors for each monitoring zone 14, 18, 20, and 24, and each named trigger event. At step 120 of FIG. 14, the main display screen, all status bars show blue indicating no trigger event has occurred. If no trigger event occurs at step 122, the system continues to display the main screen with all blue status bars. If a trigger event signal is received at step 122, the status bar associated with the camera recording the event becomes yellow. For example, status bars 123a and 123b, corresponding to a “falling bottle” at cameras 40 and 42 and sensor 30, would be yellow indicating a “falling bottle” event is being recorded. If the event is not finished being recorded, the system returns to step 124 until the event is recorded. If the event is recorded at step 126 in FIG. 13, then the status bars corresponding to the cameras recording the event become red at step 128. In FIG. 14, status bars 123a and 123b, showing the event has been logged, would be red indicating that the event has occurred and the event video has been created and stored. At step 130, if the user does not tap the red status bar 123a or 123b, the display screen continues to display video originating from cameras 40-46. If the user taps the red status bar at 132, the system goes to viewer screen 118 to display the event video file shown in FIG. 15. Viewer screen 118 includes a list of trigger events 132a, a display screen of the “falling bottle” event video from camera 42 at 132b, and controls 132c-132k provided for controlling the event viewing. Event list 132a is a complete listing of all the trigger events that have occurred from all cameras. Any of these events can be selected by tapping on an event causing the event to be displayed in viewer screen 132b. When the user taps the red status bar from the main screen, the event that has just been stored is automatically brought up and shown on event viewer screen 132b. The user may play the event with control 132c. The user may also pause, stop, rewind, fast forward and watch the display in slow motion or speed up the display video with controls 132c through 132k. The user may view as many event videos as he chooses from list 132a. Once the user is finished, he taps the close button shown as 132 L in step 132 of FIG. 14. At this point, the system returns to main display screen 116 (FIG. 14).

While a preferred embodiment of the invention has been described using specific terms, such description is for illustrative purposes only, and it is to be understood that changes and variations may be made without departing from the spirit or scope of the following claims.

What is claimed:

1. A digital diagnostic video system for diagnosing malfunctions and other errors in the operation of manufacturing machinery, said machinery having a plurality of machine sensors located at monitoring zones for detecting prescribed errors and causing sensor signals to be generated upon occurrence of said errors, said system comprising:
a video camera associated with a machine sensor located at a monitoring zone for producing real-time video output of the machinery operation desired to be monitored by said camera and sensor;
a central control unit having a computer processor continuously receiving the video output from said camera during normal machinery operation;
a temporary computer memory in communication with said processor continuously storing said video output in real time;
said processor in communication with said sensor for receiving said sensor signal to provide a trigger signal when said sensor signal is associated with a prescribed trigger event;
a permanent memory for storing a pre-event video including a first preset length of the video output depicting machinery operation occurring immediately before said trigger signal and storing a post-event video of a second preset length of the video output depicting machinery operation occurring immediately after said trigger signal;
a computer program having a set of operating instructions embodied in computer readable code executable by said processor to control the recording and storing of said pre-event and post-event videos, said program including capture instructions for copying at least said pre-event video from said temporary memory into said permanent memory in response to said trigger signal, recording said post-event video in response to said trigger signal, and saving said post-event video in said permanent memory along with said pre-event video to provide a trigger event video;
whereby said trigger event video may be displayed on said display monitor and replayed to assist in diagnosing said trigger events and errors.

2. The system of claim 1 wherein said central control unit includes a display monitor associated with said processor having a display screen for continuously displaying said video output during machinery operation.

3. The system of claim 1 including a plurality of said cameras located at a prescribed monitoring zone associated with a prescribed trigger signal and required to effectively provide video of the trigger event, and said pre-event and post-event videos containing video output from each of said cameras.

4. The system of claim 1 wherein said machinery includes a programmed logic controller (PLC) receiving said sensor signals for controlling normal machinery operation in response to said sensor signals, and said processor being in communication with said PLC to simultaneously receive and process said sensor signals for generating said trigger signal corresponding to a prescribed trigger event in machinery operation represented by one or more of said sensor signals.

5. The system of claim 4 where said processor is set up to produce said trigger signal in response to a combination of two or more of said sensor signals.

6. The system of claim 4 including a local area network (LAN) connecting said machine PLC to said control unit processor for concurrent transmission of a plurality of machine sensor signals received by said PLC from said sensors.

7. The system of claim 6 wherein said LAN includes an Ethernet, and said machine PLC includes a converter for converting said sensor signals for transmission over said Ethernet.

8. The system of claim 1 wherein said operating instructions include instructions for storing said post-event video real time in said temporary memory containing said pre-event video in response to said trigger signal, and copying said pre-event and post-event videos into a video file in said permanent memory.

9. The computer program of claim 1 wherein said operating instructions include display instructions for displaying said trigger event video in response to a view request input on said display monitor so that the machine operation before and after the trigger event may be studied for diagnostic purposes.

10. The system of claim 1 wherein said operating instructions include report instructions embodied in computer readable code for creating a video data file including said pre-event video and said post-event video, along with a time and, date, for said trigger event.

11. The system of claim 1 wherein said computer program includes set-up instructions for selecting a first preset duration for said pre-event video and a second preset duration for a said post-event video, selecting one or more machine sensor signals required to generate said trigger signal, and selecting one or more cameras producing the pre-event and post-event videos for the trigger event.

12. The system of claim 1 wherein said operating instructions include instructions for (1) continuously receiving a video of the machinery operation in real time, (2) continuously storing video in a temporary memory in real time, (3) continuously displaying the video on a display screen in real time, (4) continuously receiving available sensor signals, (5) processing said sensor signals to determine if said trigger event has occurred, and (6) continuing instructions (1) through (5) if a trigger event has not occurred.

13. The system of claim 1 wherein said operating instructions include instructions for generating said trigger signal and recording the time and date of the trigger event upon occurrence of said trigger signal; storing said video output according to a first preset duration for said pre-event video and a second preset duration for said post-event video upon occurrence of said trigger signal; copying video from said temporary memory into said permanent memory of said first preset duration to provide said pre-event video upon the occurrence of said trigger signal; beginning the recording of said post-event video upon occurrence of said trigger signal, and storing said post-event video in said permanent memory after said second preset duration has expired.

14. The system of claim 13 wherein said operating instructions include instructions for storing said post-event video real time in said temporary memory containing said pre-event video in response to said trigger signal and copying said pre-event and post-event videos into a video file in said permanent memory.

15. The system of claim 13 wherein said operating instructions include instructions for storing said pre-event and post-event video from said permanent memory in a data file along with text representing said time, date, and a trigger name identifying location of the trigger event so that video before and after the trigger event and text information can be selected and displayed to assist in the diagnosis of the trigger event.

16. The system of claim 1 wherein said display monitor includes a touch screen input for inputting data and information into said processor.

17. The system of claim 1, including a machine control and data analysis system for monitoring the production performance of the operating machinery such as down time, speed, production, and alarm signals; and
said control and data analysis system being in communication with said processor of the digital diagnostic system for displaying information from said video file along with performance data.

18. A diagnostic system for assisting in the diagnosis of a malfunction and other errors in a manufacturing process implemented by an operating machine having a plurality of machine sensors located at machine monitoring zones for detecting errors at said zones and generating sensor signals representing said errors, and a programmed logic controller (PLC) receiving said sensor signals for controlling the machinery operation in response to said sensor signals, said system comprising:
a central control unit having a computer processor in communication with a computer readable medium having a permanent memory;
a temporary computer memory in communication with said processor;
a plurality of video cameras located at said monitoring zones associated with specific sensors at said monitoring zones, said processor in communication with said cameras for receiving video output depicting the operation of the manufacturing process; and
a set of computer readable instructions embodied within said computer readable medium executable by said processor including:
set-up instructions for receiving input selecting a first preset duration for a pre-event video and a second preset duration for a post-event video from said video cameras, receiving input selecting one or more machine sensor signals required to generate trigger signals triggering production of the pre-event video and post-event video, and receiving input selecting one or more cameras producing the pre-event and post-event videos for each trigger signal, and
operating instructions executable by said processor for continuously storing video output in said temporary memory depicting machinery operation from said cameras, continuously receiving available sensor signals, processing said sensor signals to determine if a trigger signal is required, continuing the preceding operating instructions if a trigger signal is not required, and upon occurrence of a trigger signal copying video from said temporary memory into said permanent memory of said first preset duration to provide said pre-event video and beginning the recording of said post-event video and storing said post-event video in said permanent memory after said second preset duration has expired.

19. The system of claim 18 wherein said operating instructions include instructions for storing said pre-event and post-event videos in a video file in said permanent memory along with a trigger name associated with said trigger signal, and time and date information so that video output before and after the trigger event can be displayed and reviewed to assist in the diagnosis of the trigger event.

20. The system of claim 19 wherein said set-up instruction includes instructions for receiving input selecting names for trigger events corresponding to selected errors in machinery operation.

21. The system of claim 18 wherein said operating instructions include instructions for generating trigger signals and recording the time, date, and location of the trigger event upon occurrence of a trigger signal, storing said pre-event video and said post-event video according to said first preset duration and said second preset duration, respectively, in response to said trigger signal, and upon occurrence of said trigger signal copying video from said temporary memory to said permanent memory of said first preset duration to provide said pre-event video.

22. The system of claim 18 wherein said operating instructions include instructions for storing said post-event video in said temporary memory containing said pre-event video and copying said pre-event and post-event videos into a video file in said permanent memory.

23. The system of claim 18 wherein said operating instructions include display instructions continuously displaying the video on a display screen in real time concurrently with said video being stored in said temporary memory.

24. The system of claim 18 including compression chips individually associated with said video cameras in the system for compressing the video output of said cameras prior to transmitting the video output to the processor.

25. A computerized method for assisting in the diagnosis of malfunction and other errors occurring in the operation of manufacturing machinery where machine sensors are strategically placed at machinery monitoring zones prone to malfunction, said method comprising;
selecting specific errors which need to be detected in order to define trigger events at the monitoring zones requiring generation of trigger signals;
assigning a number of sensors at the monitoring zones required to detect the occurrence of a trigger event;
associating a number of video cameras with trigger events and sensors at said monitoring zones having video output sufficient to effectively diagnose errors occurring at the monitoring zones;
continuously storing the video output in real time in a temporary computer memory during operation of the machinery;
continuously displaying the video output on a display monitor in real time while simultaneously storing the video output;
producing a pre-event video from video output stored in the temporary memory upon occurrence of said trigger signal depicting machinery operation occurring before said trigger signal;
producing a post-event video upon occurrence of the trigger signal depicting machinery operation occurring after said trigger signal; and
storing said pre-event video and post-event video in a video file in a permanent computer memory of a computer readable medium along with text information identifying the trigger event.

26. The method of claim 25 including storing said post-event video in said temporary computer memory containing said pre-event video upon occurrence of said trigger signal, and saving said pre-event and post-event video from said temporary memory in said permanent memory after said post-event video is completed.

27. The method of claim 25 including compressing said video output prior to transmitting said video output to said temporary memory.

28. A computerized method for diagnosing errors in manufacturing processes implemented by operating machinery having machine sensors for sensing operational errors, and a machine controller for controlling the machinery operation in response to the sensor signals, said method comprising:
sensing machinery operation malfunction and other errors and generating sensor signals representing the errors;
pre-defining triggers signals based on said sensor signals for controlling real time storage of video output from one or more video cameras;
executing computer readable instructions embodied in a computer readable medium on a computer processor including:
continuously storing said video output in temporary memory in real time;
displaying said input from video cameras on a display screen in real time;
communicating sensor signals from the machinery controller to said computer processor;
recording date and time, identification of the sensors generating said sensor signal;
processing the sensor signals and generating a trigger signal in response by one or more sensor signals; representing a pre-defined trigger event;
storing said video output stored in temporary memory into permanent memory upon occurrence of said video signal;
creating a trigger video file containing said date, time, and identification of said trigger event; and
saving said video in a computer readable medium.

29. The method of claim 28 including storing a first preset amount of said video output as a pre-event video depicting machinery operation occurring before the trigger signal and storing a video output as a post-event video depicting the machinery after occurrence of the trigger signal.

30. The method of claim 29 including storing said pre-event video in temporary memory immediately upon occurrence of said trigger signal currently with beginning storage of said post-event video in said temporary memory, and saving said pre-event and post-event videos in a video file in permanent computer memory.

31. The method of claim 29 including providing a computer processor having computer readable medium containing said permanent memory, and a temporary computer memory in communication with said computer readable medium; wherein said method includes the steps of allocating portions of said temporary memory for storing video output from said video cameras to define preselected memory amounts for said pre-event and post-event videos in temporary memory; and storing said pre-event and post-event videos in said preselected memory amounts for said video cameras upon occurrence of trigger signals associated with said cameras.

32. The method of claim 29 including set up instructions for receiving an input selection to preset the allocation of said pre-event video and said post-event video in said preselected memory amounts.

33. The method of claim 32 including allocating said preselected memory amounts to generally equal the total amount of pre-event and post-event video corresponding to said preset durations.

34. The method of claim 33 including the steps of selecting errors requiring trigger signals, assigning sensors to detect the selected errors, and associating certain video cameras with said selected errors at predetermined area of the operating machinery required to adequately video events surrounding the trigger signals.

35. The method of claim 31 including receiving said sensor signals at the machine controller for the machinery, and simultaneously transmitting said sensor signals over a local area network to said computer processor.

36. The method of claim 28 including discontinuing operation of said machinery in response to said trigger signal.

37. The method of claim 28 including compressing said video output prior to transmitting said video output to said temporary memory.
